(19) United States
(12) Patent Application Publication
(10) Pub. No.: US 2009/0177637 A1
(43) Pub. Date: Jul. 9, 2009

(54) NDMA DB SCHEMA, DICOM TO RELATIONAL SCHEMA TRANSLATION, AND XML TO SQL QUERY TRANSLATION

(75) Inventor: ROBERT J. HOLLEBEEK, Berwyn, PA (US)

Correspondence Address: RATNERPRESTIA, P.O. BOX 980, VALLEY FORGE, PA, 19482, US

(73) Assignee: The Trustees of the University of Pennsylvania, Philadelphia, PA (US)

(21) Appl. No.: 12/404,633

(22) Filed: Mar. 16, 2009

Related U.S. Application Data
(63) Continuation of application No. 10/559,248, filed on May 2, 2006, now abandoned.
(60) Provisional application No. 60/476,117, filed on Jun. 4, 2003.

(51) Int. Cl. G06F 17/30; G06Q 10/00

(52) U.S. Cl. 707/3; 707/104.1; 707/E17.019; 707/E17.044; 705/2

(57) ABSTRACT

A translation scheme translates DICOM content into a format compatible for storage in an NDMA relational database. The translation scheme employs a schema for indexing the DICOM content, and employs a mechanism for translating queries embedded in XML into SQL. The translation scheme translates DICOM compatible data into a tab delimited flat representation of the DICOM content. The flat representation is then translated into data compatible with a relational database format, such as SQL, and then into database insert commands. The schema enables capture of the DICOM information into relational tables. Methods are also provided to service XML formatted research and clinical queries, to translate XML queries to optimized SQL and to return query results to XML specified destinations with record de-identification where required. Methods are also provided to interface to NDMA WallPlugs, secured query devices, or GRID devices.

### CROSS REFERENCE TO RELATED APPLICATIONS

The present application claims priority to U.S. Provisional Application No. 60/476,117, filed Jun. 4, 2003, entitled “NDMA DB SCHEMA, DICOM TO RELATIONAL SCHEMA TRANSLATION, AND XML TO SQL QUERY TRANSLATION,” which is hereby incorporated by reference in its entirety. The subject matter disclosed herein is related to the subject matter disclosed in U.S. patent application serial number (Attorney Docket UPN-4380/P3179, filed on even date herewith and entitled “CROSS-ENTERPRISE WALLPLUG FOR CONNECTING INTERNAL HOSPITAL/CLINIC MEDICAL IMAGING SYSTEMS TO EXTERNAL STORAGE AND RETRIEVAL SYSTEMS”, the disclosure of which is hereby incorporated by reference in its entirety. The subject matter disclosed herein is also related to the subject matter disclosed in U.S. patent application serial number (Attorney Docket UPN-4381/P3180), filed on even date herewith and entitled “NDMA SOCKET TRANSPORT PROTOCOL”, the disclosure of which is hereby incorporated by reference in its entirety. The subject matter disclosed herein is further related to the subject matter disclosed in U.S. patent application serial number (Attorney Docket UPN-4382/P3189), filed on even date herewith and entitled “NDMA SCALABLE ARCHIVE HARDWARE/SOFTWARE ARCHITECTURE FOR LOAD BALANCING, INDEPENDENT PROCESSING, AND QUERYING OF RECORDS”, the disclosure of which is hereby incorporated by reference in its entirety.

### FIELD OF THE INVENTION

The present invention generally relates to data transformation and, more particularly, to transforming data to provide compatibility between DICOM compatible systems and NDMA compatible systems.

### BACKGROUND

Prior systems for storing digital mammography data included making film copies of the digital data, storing the copies, and destroying the original data Distribution of information basically amounted to providing copies of the copied x-rays This approach was often chosen due to the difficulty of storing and transmitting the digital data itself. The introduction of digital medical image sources and the use of computers in processing these images after their acquisition has led to attempts to create a standard method for the transmission of medical images and their associated information. The established standard is known as the Digital Imaging and Communications in Medicine (DICOM) standard. Compliance with the DICOM standard is crucial for medical devices requiring multi-vendor support for connections with other hospital or clinic resident devices.

The DICOM standard describes protocols for permitting the transfer of medical images in a multi-vendor environment, and for facilitating the development and expansion of picture archiving and communication systems and interfacing with medical information systems. It is anticipated that many (if not all) major diagnostic medical imaging vendors will incorporate the DICOM standard into their product design. It is also anticipated that DICOM will be used by virtually every medical profession that utilizes images within the healthcare industry. Examples include cardiology, dentistry, endoscopy, mammography, opthalmology, orthopedics, pathology, pediatrics, radiation therapy, radiology, surgery, and veterinary medical imaging applications. Thus, the utilization of the DICOM standard will facilitate communication and archiving of records from these areas in addition to mammography. Therefore, a general method for interfacing between instruments inside the hospital and external services acquired through networks and of providing services as well as information transfer is desired. It is also desired that such a method enable secure cross-enterprise access to records with proper tracking of accessed records in order to support a mobile population acquiring medical care at various times from different providers.

In order for imaging data to be available to a large number of users, an archive is appropriate. The National Digital Mammography Archive (NDMA) is such an archive for storing digital mammography data. The NDMA acts as a dynamic resource for images, reports, and all other relevant information tied to the health and medical record of the patient. Also, the NDMA is a repository for current and previous year studies and provides services and applications for both clinical and research use. The development of such a national breast imaging archive may very well revolutionize the breast cancer screening programs in North America However, the privacy of the patients is a concern. Thus, the NDMA ensures the privacy and confidentiality of the patients, and is compliant with all relevant federal regulations.

To facilitate distribution of this imaging data, DICOM compatible systems should be coupled to the NDMA. To reach a large number of users, the Internet would seem appropriate; however, the Internet is not designed to handle the protocols utilized in DICOM. Therefore, while NDMA supports DICOM formats for records and supports certain DICOM interactions within the hospital, NDMA uses its own protocols and procedures for file transfer, manipulation, and transport.

Previous attempt to convert DICOM data formats are described in published U.S. Patent Application No. 2002/0143727 (Hu et al.), U.S. Patent Application No. 2002/0143824 (Lee et al.), and U.S. Patent Application No. 2002/0005464 (Gropper et al.). Hu et al. teaches a DICOM-to-XML conversion system that converts the DICOM SR (structured reporting) standard into a set of XML DTDs (document type definitions) and sSchemas. Lee et al. teaches a conversion system that converts a DICOM formatted file into an XML representation. Gropper et al. teaches a method for storing an image, such as a DICOM image in a repository. However, none of these documents address formatting DICOM data for compatibility with the NDMA.

Thus, a need exists for a mechanism that couples DICOM compatible systems to the NDMA and that provides compatibility of data transferred between the systems. There is also a need for this mechanism to maintain privacy, security, and not hamper operations on the hospital/clinic side (DICOM) or the NDMA side.

### SUMMARY OF THE INVENTION

A translation scheme that translates DICOM content to a format compatible with an NDMA compatible relational database employs a schema for indexing the DICOM content, and employs a mechanism for translating queries embedded in XML to SQL (structured query language). The translation scheme translates DICOM content to a relational database, a schema for indexing the DICOM content, and a mechanism for translating queries embedded in XML to SQL. The translation scheme translates DICOM compatible data into a tab delimited flat representation of the DICOM content. The flat representation of the DICOM content is then translated into data compatible with a relational database format, such as SQL. The database compatible representation is then formatted into database insert commands. The scheme enables capture of the DICOM information into relational tables.

The translation scheme further provides compatibility of data transferred between DICOM compatible systems and NDMA compatible systems and databases. This scheme maintains privacy, security, and does not hamper operations on the hospital/clinic side (DICOM). This scheme also maintains encryption on the external network side, provides strong authentication, and external management, and can efficiently handle transfers of large amounts of data between the DICOM system and the NDMA. Also, the scheme allows incoming XML and DICOM content to be stored and indexed in the archive (NDMA), automatically accepts any DICOM content and indexes it, and provides query/retrieve mechanisms specified in XML.

The translation scheme in accordance with an exemplary embodiment of the present invention, transforms DICOM compatible data to data compatible with an NDMA compatible relational database by transforming the DICOM compatible data into an intermediate format. The intermediate formatted data is then formatted into data compatible with the NDMA compatible relational database format.

### BRIEF DESCRIPTION OF THE DRAWINGS

FIG. 1 is a block diagram of firewalled hospital systems coupled to a WallPlug via a TCPIP compatible network, secured query devices and GRID connections coupled to an archive, and an archive coupled to the WallPlug via a virtual private network in accordance with an embodiment of the present invention;

FIG. 2 is a block diagram of the NDMA Archive System in accordance with an embodiment of the present invention; and

FIG. 3 is a diagram depicting the translation process in accordance with an exemplary embodiment of the present invention.

### DESCRIPTION OF EMBODIMENTS OF THE INVENTION

In an exemplary embodiment of the present invention, the translation scheme is implemented in a system comprising a DICOM compatible system (e.g., at a hospital or clinical institution), an NDMA compatible system comprising at least one relational database for storage and retrieval of archived information (e.g., digital mammography images), and a WallPlug coupling the two systems.

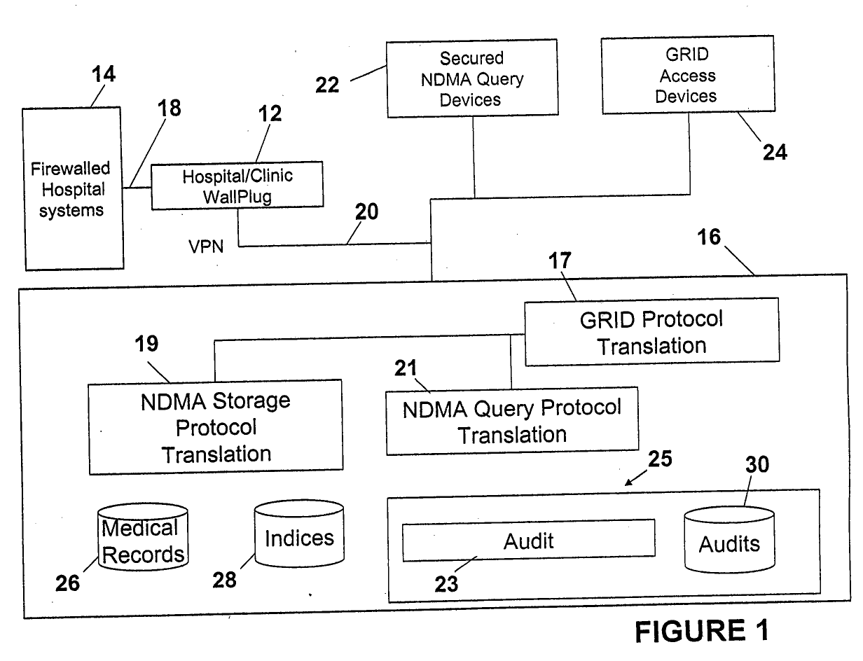

FIG. 1 is a diagram illustrating a firewalled hospital system 14 coupled to a WallPlug 12 via a TCPIP compatible network 18, secured NDMA query devices 22 and GRID connections 24 coupled to an NDMA archive 16, and the archive 16 coupled to the WallPlug 12 via a virtual private network 20. Grid compatible systems use Open Grid Standards for system authentication and for locating and using services, and NDMA compatible systems use NDMA protocols for authentication and acquiring services. The NDMA archive 16, as depicted in FIG. 1, accepts streams of NDMA protocol wrapped DICOM and DICOM SR (DICOM structured report) content from the front end of the WallPlug 12 and stores the content on large scale storage media (e.g., databases 26, 28, and/or 30) while simultaneously and automatically indexing the DICOM header and DICOM SR content in a relational database 28. WallPlugs, such as the WallPlug 12, are portal systems used to couple the NDMA archives (e.g., archive 16) with the DICOM compatible systems (e.g., hospital system 14). For a better understanding of the WallPlug 12, please refer to the related application entitled, “CROSS-ENTERPRISE WALLPLUG FOR CONNECTING INTERNAL HOSPITAL/CLINIC MEDICAL IMAGING SYSTEMS TO EXTERNAL STORAGE AND RETRIEVAL SYSTEMS”, Attorney Docket UPN-4380/P3179, filed on even date herewith, the disclosure of which is hereby incorporated by reference in its entirety. The archive 16 also accepts streams of NDMA protocol wrapped queries which can be executed against the relational database to extract DICOM and DICOM SR content and return it to the WallPlugs 12. The archive 16 also accepts GRID protocols for storage retrieval and services.

The WallPlug 12 has two network connections. One is connected to the hospital network 18 and the other is connected to an encrypted external Virtual Private Network (VPN) 20. The WallPlug 12 also presents a secure web user interface and a DICOM hospital instrument interface on the hospital side and a secure connection to the archive on the VPN side. The WallPlug 12 makes no assumptions about external connectivity of the connected hospital systems.

The archive 16 can be coupled to any of several network configurations. That is, the archive 16 has multiple modes of network connection. In one configuration, the archive 16 is coupled to the hospital networks via the encrypted VPN 20 attachments to WallPlugs 12. In another configuration, the archive 16 is coupled to the secured query stations 22. In yet another configuration, the archive 16 is coupled to the GRID systems 24. Each configuration utilizes a network, a transport protocol, and some middleware. The middleware can form a portion of the archive 16, a connection point, or a combination thereof. Incoming items for storage are translated from NDMA 19 or GRID 17 protocols and stored in medical records stores 26, and all content is indexed in a database 28. Incoming queries for storage are translated from NDMA 19 or GRID 17 protocols and retrieved from medical records stores 26, using automatic translation of the XML query syntax applied to indices in a database 28. Incoming requests for services are translated from NDMA 19 or GRID 17 protocols and applied to stored items in the medical records stores 26 or received items, and all results are indexed in a database 28. All requests for storage, retrieval, or services are audited by an audit process 25, and all actions are recorded by the audit software 23 in audit database 30 which can be either separate from or the part of the storage/retrieval database 28. Properly secured external devices 22 are those which have a browser enabled by a client certificate issued by NDMA or by a browser authenticated by smartcard or other security devices and authentication tokens issued by NDMA, and which are allowed in the NDMA security tables. These devices can execute queries against the data using the NDMA protocol. The translation in this case from an internal web query to the NDMA protocol is accomplished through an externally accessible WallPlug 12. Grid Access devices 24 connect to the archive through a Grid protocol translation 17 which interfaces to NDMA protocols. Storage requests are translated from NDMA protocol to DB commands through the NDMA Storage Protocol Translation 19 and query requests are translated through the NDMA query Protocol Translation 21.

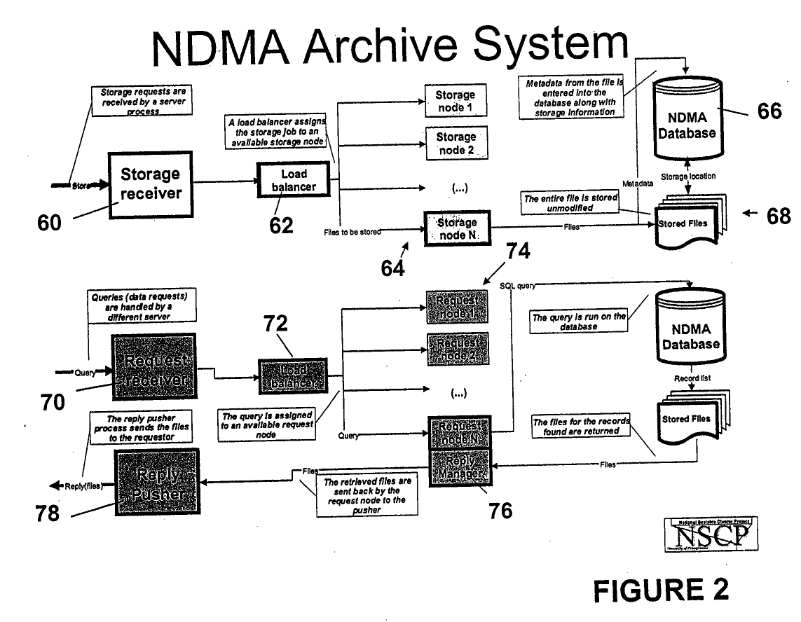

FIG. 2 illustrates an overview and the basic components of the archive (NDMA) system 16 for storage, indexing and retrieval. Incoming storage requests are handled by a storage receiver 60 of which there may be one or several instances distributed across one or more machines. The load balancer (senders) 62, of which there can be many, push incoming storage requests to Storage nodes 64 using any appropriate load balancing technique. Storage nodes 64 store files in their managed file spaces 68 and indices in the database 66. At the conclusion of a successful store, a reply message is generated and placed in the reply queue (not shown in FIG. 2). This reply is automatically routed by the Reply Pusher 78 discussed below.

Incoming query requests are handled by a request receiver 70, of which there can be one or several instances distributed across one or more machines the same as or different from the machines handling the storage requests. The load balancer (senders) 72, of which there can be many, push incoming query requests to the request nodes 74 using any appropriate load balancing technique. The request nodes 74 query the indices 66 and locate all files necessary to satisfy the request. In the case of files managed locally, the files are fetched and formatted according to NDMA protocols by the Reply Manager 76. Completed replies are sent to the reply pusher 78 which routes them back to the requesting location. For files which are not local, the Reply Manager 76 sends the protocol elements back to the load balancer 72 which directs the request to the reply manager 76 on the node which controls the data. This node then completes the process by fetching the requested file, attaching the protocol elements, and sending the file to the reply pusher. The latter more complicated procedure is used to maintain record level independence and to avoid direct network traffic crossing between request nodes.

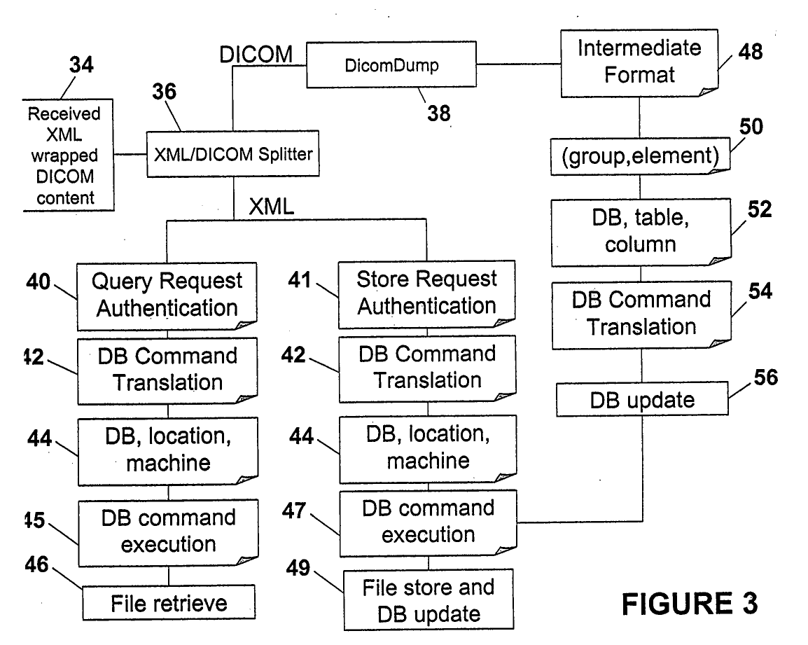

FIG. 3 is a diagram depicting the translation process in accordance with an exemplary embodiment of the present invention. As illustrated in FIG. 3, the XML wrapped DICOM content (represented by block 34 of FIG. 3) comprises incoming content and requests that have NDMA protocol XML headers and DICOM content. For a better understanding of this protocol, please refer to the related application entitled, “NDMA SOCKET TRANSPORT PROTOCOL”, Attorney Docket UPN-4381/P3180, filed on even date herewith, the disclosure of which is hereby incorporated by reference in its entirety. The text and binary components of the XML wrapped DICOM content 34 are split by the XML/DICOM splitter process 36 into DICOM components and XML components. Note that storage requests contain binary DICOM components. The binary DICOM components are processed by the DicomDump process 38, which converts DICOM content to an intermediate format 48 for further translation. In the intermediate format 48, the DICOM content is organized into items comprising a group and an element. The DICOM (group, element) items 50 are translated via database tables to a relational database representation 52 containing identifiers for the database, the table, and the column (database, table, column), and to database commands 54. Referring again to the XML/DICOM splitter process 36, the XML components containing authentication information are used to determine whether access is allowed for queries 40 or for storage 41 requests and to additionally locate storage locations for storage requests and queries 44. Queries continuing XML representations of DICOM (group, element) queries and/or NDMA items are translated to (database, table, column) representation 42 and then to database queries 45. Storage requests are translated to database commands 47 which include items prepared from the binary DICOM 56.

### DicomDump

The DicomDump process 38 is the first step in the DICOM to relational database index translation. In an exemplary embodiment, versions of the software developed to implement the DicomDump process 38 are compatible with WINDOWS® and UNIX® based platforms. The DicomDump process walks through (traverses) a DICOM or DICOM SR file and verifies the file for legitimate format and produces a standardized output file or memory resident structure. The file or memory resident structure is used to display information in the file. It is also used as input into the first step of populating an index for the information. This intermediate format is a flat representation of the data which is tab delimited for subitems and CR/LF (carriage return/line feed) delimited for items. It can be serialized into a flat file. The intermediate output has the form (group in hex, element in hex) (tab) (length in bytes) (tab) VR (value representation) (tab) Description (tab) Content (CR/LF). An exemplary intermediate format is shown below. In the list below, the binary DICOM content has been translated to a group element “(2, 0)”, followed by the length of the data for that group, element “(4)” followed by a type indicator (VR) “UL” followed by a description “Group 0002 Length” followed by the actual content “178”. VR is a DICOM defined descriptor of the data type of the value for the group/element pair. For example, (group, element) equal to (8.23) has a VR of DA which identifies the specified value of “2000503” as a date, i.e. May 3, 2000.

DicomDump Example Output in Intermediate Format

Filename C:\MARecv\127.0.0.1\hat{ }nscpDcm\hat{ }4600\hat{ }testfile

| | |
|---|---|
| ( 2, 0) ( 4) UL Group 0002 Length | 178 |
| ( 2, 1) ( 2) OB File Meta Information Version | |
| ( 2, 2) ( 28) UI Media Stored SOP Class UID | |
| 1.2.840.10008.5.1.4.1.1.1.2 | |
| ( 2, 3) ( 48) UI Media Stored SOP Instance UID | |

1.2.840.113619.2.76.2158572937.561.959791758.941

| | |
|---|---|
| ( 2, 10) ( 18) UI Transfer Syntax UID | 1.2.840.10008.1.2 |
| ( 2, 12) ( 18) UI Implementation Class UID | 1.2.40.0.12.0.9907 |
| ( 2, 13) ( 12) SH Implementation Version Name | |
| ( 8, 5) ( 10) CS Specific Character Set | ISO_IR 100 |
| ( 8, 8) ( 18) CS Image Type | ORIGINAL\PRIMARY\ |
| ( 8, 16) ( 28) UI SOP Class UID | |
| 1.2.840.10008.5.1.4.1.1.1.2 | |
| ( 8, 18) ( 48) UI SOP Instance UID | |

1.2.840.113619.2.76.2158572937.561.959791758.941

| | |
|---|---|
| ( 8, 20) ( 8) DA Study Date | 20000503 |
| ( 8, 21) ( 8) DA Series Date | 20000503 |
| ( 8, 22) ( 8) DA Acquisition Date | 20000503 |
| ( 8, 23) ( 8) DA Image Date | 20000503 |
| ( 8, 30) ( 14) TM Study Time | 150032.000000 |
| ( 8, 31) ( 14) TM Series Time | 150433.000000 |
| ( 8, 32) ( 14) TM Acquisition Time | 150542.000000 |
| ( 8, 33) ( 14) TM Image Time | 150554.000000 |
| ( 8, 50) ( 0) SH Accession Number | |
| ( 8, 60) ( 2) CS Modality | MG |
| ( 8, 68) ( 16) CS Presentation Intent Type | FOR PRESENTATION |
| ( 8, 70) ( 18) LO Manufacturer | GE MEDICAL SYSTEMS |
| ( 8, 80) ( 6) LO Institution Name | SWCHSC |
| ( 8, 90) ( 12) PN Referring Physician's Name | |
| ( 8, 1010) ( 10) SH Station Name | SWCHSC-AWS |
| ( 8, 1030) ( 8) LO Study Description | bil scr |
| ( 8, 103e) ( 6) LO Series Description | dense |
| ( 8, 1050) ( 2) PN Attending Physician's Name | rs |
| ( 8, 1070) ( 2) PN Operator's Name | jg |
| ( 8, 1090) ( 8) LO Manufacturer's Model Name | ADS_1.0 |
| ( 8, 2112) ( 0) SQ Source Image Sequence | |
| (fffe, e000) ( 0) DL Item | |
| ( 8, 1150) ( 30) UI Referenced SOP Class UID | |
| 1.2.840.10008.5.1.4.1.1.1.2.1 | |
| ( 8, 1155) ( 50) UI Referenced SOP Instance UID | |

1.2.840.113619.2.66.2159378590.11312000503150544.3
(fffe, e00d) ( 0) DL Item Delimitation Item
(fffe, e0dd) ( 0) DL Sequence Delimitation Item
( 8, 2218) ( 0) SQ Anatomic Region Sequence
(fffe, e000) ( 0) DL Item

| | |
|---|---|
| ( 8, 100) ( 8) SH Code Value | T-04000 |
| ( 8, 102) ( 4) SH Coding Scheme Designator | SNM3 |
| ( 8, 104) ( 6) LO Code Meaning | BREAST |
| (fffe, e00d) ( 0) DL Item Delimitation Item | |
| (fffe, e0dd) ( 0) DL Sequence Delimitation Item | |
| ( 10, 10) ( 0) PN Patient's Name | |
| ( 10, 20) ( 22) LO Patient ID | |
| IOP2679.896.959791758 | |
| ( 10, 30) ( 0) DA Patient's Birth Date | |
| ( 10, 40) ( 2) CS Patient's Sex | F |
| ( 10, 1000) ( 0) LO Other Patient IDs | |
| ( 10, 1001) ( 0) PN Other Patient Names | |
| ( 10, 1040) ( 0) LO patient's Address | |
| ( 10, 2154) ( 0) SH Patient's Telephone Numbers | |
| ( 18, 15) ( 6) CS Body Part Examined | BREAST |
| ( 18, 60) ( 2) DS KVP | 29 |
| ( 18, 1020) ( 48) LO Software Versions | |

Ads Application Package xxxx VERSION ADS_8.12.1

| | |
|---|---|
| ( 18, 1110) ( 4) DS Distance Source to Detector | 660 |
| ( 18, 1111) ( 4) DS Distance Source to Patient | 660 |

( 18, 1114) ( 2) DS Estimated Radiographic Magnification Factor12.1 1

| | |
|---|---|
| ( 18, 1147) ( 10) CS Field of View Shape | RECTANGLE |
| ( 18, 1149) ( 8) IS Field of View Dimensions | 229\191 |
| ( 18, 1150) ( 4) IS Exposure Time | 1024 |
| ( 18, 1151) ( 2) IS X-ray Tube Current | 73 |
| ( 18, 1152) ( 2) IS Exposure | 72 |
| ( 18, 1153) ( 6) IS Exposure in uAs | 72200 |
| ( 18, 1160) ( 6) SH Filter Type | STRIP |
| ( 18, 1164) ( 8) DS Imager Pixel Spacing | 0.1\0.1 |
| ( 18, 1166) ( 24) CS Grid | |
| RECIPROCATING\PARRALLEL | |
| ( 18, 1190) ( 4) DS Focal Spot | 0.3 |
| ( 18, 1191) ( 8) CS Anode Target Material | RHODIUM |
| ( 18, 11a0) ( 2) DS Body Part Thickness | 43 |
| ( 18, 11a2) ( 2) DS Compression Force | 50 |

( 18, 1400) ( 6) LO Acquisition Device Processing Descriptionor12.1 PROC_1
( 18, 1401) ( 14) LO Acquisition Device Processing Code GEMS_FFDM_TC_1

| | |
|---|---|
| ( 18, 1405) ( 2) IS Relative X-ray Exposure | 6 |
| ( 18, 1508) ( 12) CS Positioner Type | MAMMOGRAPHIC |
| ( 18, 1510) ( 2) DS Positioner Primary Angle | 0 |
| ( 18, 1530) ( 2) DS Detector Primary Angle | 0 |
| ( 18, 1700) ( 12) CS Collimator Shape | RECTANGULAR |
| ( 18, 1702) ( 2) IS Collimator Left Vertical Edge | 0 |
| ( 18, 1704) ( 2) IS Collimator Right Vertical Edge | 0 |

| | |
|---|---|
| ( 18, 1706) ( 2) IS Collimator Upper Horizontal Edge | 0 |
| ( 18, 1708) ( 2) IS Collimator Lower Horizontal Edge | 0 |

| | |
|---|---|
| ( 18, 5101) ( 2) CS View Position | CC |

| | |
|---|---|
| ( 18, 7000) ( 4) CS Detector Conditions Nominal Flag | YES |

| | |
|---|---|
| ( 18, 7001) ( 4) DS Detector Temperature | 36.8 |
| ( 18, 7004) ( 12) CS Detector Type | SCINTILLATOR |
| ( 18, 7005) ( 4) CS Detector Configuration | AREA |
| ( 18, 700a) ( 12) SH Detector ID | &FFDM1.8.3 |
| ( 18, 701a) ( 4) DS Detector Binning | 1\1 |

| | |
|---|---|
| ( 18, 7020) ( 10) DS Detector Element Physcal Size | 192\230.4 |

| | |
|---|---|
| ( 18, 7022) ( 8) DS Detector Element Spacing | 0.1\0.1 |
| ( 18, 7024) ( 10) CS Detector Active Shape | RECTANGLE |

| | |
|---|---|
| ( 18, 7026) ( 10) DS Detector Active Dimension(s) | 192\230.4 |

| | |
|---|---|
| ( 18, 7030) ( 4) DS Field of View Origin | 5\1 |
| ( 18, 7032) ( 2) DS Field of View Rotation | 0 |
| ( 18, 7034) ( 2) CS Field of View Horizontal Flip | NO |
| ( 18, 7050) ( 8) CS Filter Material | RHODIUM |
| ( 18, 7060) ( 10) CS Exposure Control Mode | AUTOMATIC |

( 18, 7062) ( 50) LT Exposure Control Mode Description
AOP dose RECTANGLE 1252 mm 810 mm 100 mm 100 mm

| | |
|---|---|
| ( 18, 7064) ( 6) CS Exposure Status | NORMAL |
| ( 20, d) ( 48) UI Study Instance UID | |

```
  1.2.840.113619.2.76.2158572937.561.959791758.939
( 20, e) ( 48) UI Series Instance UID
  1.2.840.113619.2.76.2158572937.561.959791758.940
```

| | |
|---|---|
| ( 20, 10) ( 4) SH Study ID | 103 |
| ( 20, 11) ( 4) IS Series Number | 176 |
| ( 20, 13) ( 2) IS Image Number | 2 |
| ( 20, 20) ( 4) CS Patient Orientation | A\R |
| ( 20, 62) ( 2) CS Image Laterality | L |
| ( 28, 2) ( 2) US Samples per Pixel | 1 |
| ( 28, 4) ( 12) CS Photometric Interpretation | MONOCHROME2 |
| ( 28, 10) ( 2) US Rows | 2294 |
| ( 28, 11) ( 2) US Columns | 1914 |
| ( 28, 100) ( 2) US Bits Allocated | 16 |
| ( 28, 101) ( 2) US Bits Stored | 12 |
| ( 28, 102) ( 2) US High Bit | 11 |
| ( 28, 103) ( 2) US Pixel Representation | 0 |
| ( 28, 300) ( 2) CS Quality Control Image | NO |
| ( 28, 301) ( 2) CS Burned In Annotation | NO |
| ( 28, 1040) ( 4) CS Pixel Intensity Relationship | LOG |

| | |
|---|---|
| ( 28, 1041) ( 2) SS Pixel Intensity Relationship Sign | −1 |
| ( 28, 1050) ( 14) DS Window Center | 2335\2353\2311 |
| ( 28, 1051) ( 12) DS Window Width | 750\600\900 |
| ( 28, 1052) ( 2) DS Rescale Intercept | 0 |
| ( 28, 1053) ( 2) DS Rescale Slope | 1 |
| ( 28, 1054) ( 2) LO Rescale Type | US |

( 28, 1055) ( 20) LO Window Center & Width
Explanation NORMAL\HARDER\SOFTER

| | |
|---|---|
| ( 28, 2110) ( 2) CS Lossy Image Compression | 00 |
| ( 40, 302) ( 2) US Entrance Dose | 0 |
| ( 40, 306) ( 4) DS Distance Source to Entrance | 617 |
| ( 40, 310) ( 4) ST Comments on Radiation Dose | 76% |
| ( 40, 316) ( 8) DS Organ Dose | 0.01471 |
| ( 40, 318) ( 6) CS Organ Exposed | BREAST |
| ( 40, 555) ( 0) SQ Acquisition Context Sequence | |
| ( 45, 10) ( 12) Unknown | GEMS_SENO_02 |
| ( 45, 101b) ( 4) Unknown | LCC |
| ( 45, 1020) ( 10) Unknown | 1360.5325 |
| ( 45, 1026) (1024) Unknown | |
| | ... |
| ( 45, 1029) ( 14) Unknown | 1265\4.4000001 |
| ( 45, 102a) ( 12) Unknown | −1 |
| ( 45, 102b) ( 12) Unknown | −1 |
| ( 45, 1049) ( 2) Unknown | 50 |
| ( 45, 1050) ( 50) Unknown | |

```
  1.2.840.113619.2.66.2159378590.1672000503150554.12
(45.1051) (54)  Unknown
  1.2.840.113619.2.66.2159378590.11312000503150433.10004
```

| | |
|---|---|
| ( 45, 1058) ( 10) Unknown | 0.80000001 |
| ( 45, 1059) ( 4) Unknown | 2088 |
| ( 45, 1060) ( 14) Unknown | 0\1172\1172\0 |
| ( 45, 1061) ( 18) Unknown | 349\349\2189\2189 |
| ( 45, 1062) ( 12) Unknown | 2029 |
| ( 45, 1063) ( 12) Unknown | 1667 |
| ( 45, 1064) ( 2) Unknown | 31 |
| (54, 220) ( 0) SQ View Code Sequence | |
| (fffe, e000) ( 0) DL Item | |
| ( 8, 100) ( 8) SH Code Value | R-10242 |
| ( 8, 102) ( 4) SH Coding Scheme Designator | SNM3 |
| ( 8, 104) ( 14) LO Code Meaning | cranio-caudal |
| (54, 222) ( 0) SQ View Modifier Code Sequence | |
| (fffe, e00d) ( 0) DL Item Delimitation Item | |
| (fffe, e0dd) ( 0) DL Sequence Delimitation Item | |
| (88, 200) ( 0) SQ Icon Image Sequence | |
| (fffe, e000) ( 0) DL Item | |
| ( 28, 2) ( 2) US Samples per Pixel | 1 |
| ( 28, 4) ( 12) CS Photometric Interpretation | MONOCHROME2 |
| ( 28, 10) ( 2) US Rows | 64 |
| ( 28, 11) ( 2) US Columns | 53 |
| ( 28, 100) ( 2) US Bits Allocated | 16 |
| ( 28, 101) ( 2) US Bits Stored | 14 |
| ( 28, 102) ( 2) US High Bit | 13 |
| ( 28, 103) ( 2) US Pixel Representation | 0 |
| (7fe0, 10) (6784) OW Pixel Data | [3930 6784] |
| (fffe, e00d) ( 0) DL Item Delimitation Item | |
| (fffe, e0dd) ( 0) DL Sequence Delimitation Item | |
| (2050, 20) ( 8) CS Presentation LUT Shape | IDENTITY |
| (7fe0, 10) (8781432) OW Pixel Data | [10754 8781432] |

### DICOM (Group, Element) Translation

The next step in the construction of a relational database index of the DICOM content is to translate the intermediate format into an SQL insert (SQL compatible format) at DB command translation step 54 (FIG. 3). In an exemplary embodiment, the DICOM items are translated into table column names. This is accomplished by using a column name that is easily derived from the DICOM item. The column name used for an item in the intermediate format as (group, element)=(gg, ee) is HggHee. For example, a patient name which is a group 10 element 10, i.e., (10, 10), is encoded in a column having the column name H10H10. This translation allows one to automatically derive a column name for any DICOM group element combination in the DICOM record.

Utilizing the translation scheme in accordance with the present invention, any DICOM data item can be associated with a column name. Also, each column is associated with a database table name. This assignment is table driven and a lookup function returns the table name for each (group, element) including a default table as described below.

### Level 1, 2, 3 Tables

In the NDMA database schema of the invention, a level of interest is associated with each data element. There are three levels of interest. The first level contains data elements that are most likely to be used in subsequent queries and therefore are preferably optimized. These include items such as patient name, patient ID, date of birth, attending physician, etc. These content items are placed in two tables, tbl_main, and tbl_dicom_small. These and the other table to follow are located in the indices table 28. The second level of interest contains elements of interest that may be queried, but with less frequency than elements in the first level of interest. These items are contained in tbl_dicom_all_a, tbl_dicom_all_b, tbl_dicom_all_c, tbl_dicom_all_d, tbl_dicom_all_e, tbl_dicom_all_f, and tbl_dicom_all_g. Items are grouped in these tables based on the likelihood that they would be used simultaneously in a query. This arrangement of multiple tables keeps the tables small and the grouping helps eliminate table joins for queries. The third level of interest table comprises all other elements. Because this table may also include sequence items, and because it is able to store arbitrary (group, element) items, the table is a rotated one, i.e. it has a foreign key, and an entry for each (group, element) encountered. The table name is tbl_dicom_rest.

### Location Tables

For each record stored, there is also recorded the machine, data system, and file name of the stored record. This information is stored in a table named tbl_locations. This table can have multiple locations to enable the storage of primary records, backup copies, and cached content on other servers. A listing of sample tables follows.

LU_BiRADS

The LU_BiRADS table is used to determine the relationships among between the following items:
a automated DICOM_DUMP name of a BiRADS item (BI001 thru BI126) BiRADS is the standard for the results of an exam—this standard was established by the American College of Radiology]
common name of the item (used for printing reports)
NDMANAME (XML tag for an item)
Data type
   This table allows NDMA to translate BiRads records to table entries and XML tags to BiRads elements in such a way that additional customized elements can be added to these medical records as necessary.

LU_Portals

This table contains the identifying information for portals allowed to connect to the system. It contains:
Portal ID
Certificate Hash
IP address
Hostname
Common Name (used for reports)

LU_portals_Groups

This table is used to assign portalIDs to PortalGroups.
A need arises in NDMA to determine whether hospital enterprises are or are not willing to exchange records. Portal groups represent groups of portals that will exchange data.

LU_DICOM_DICT

This table is used to drive the DICOM_DUMP. Table elements include:
GROUPELEMENT (for example H10H10)
Type (standard DICOM twochar types)
CommonName
NDMANAME (allows XML to use common names rather than GROUPELEMENT)
TableName (table where item is indexed)
Level
   This table provides a flexible, expandable and customizable translation between XML tags and DICOM elements.

LU_NON_DICOM_DICT

This table includes definitions of other non-DICOM names:
FieldName
Type
CommonName
NDMANAME
TableName
Level

LU_Groups

This table is used to identify portal groups:
GroupID
CommonName

LU_Group_Allow

This table is used to control data exchange between groups.

LU_Locations

This table Storage locations—identifies storage locations of possible node storage systems:
LOCID
IP
Storage level
dirName
LibName

LU_Storage_Levels

This table includes a list of possible storage levels.

TBL_Audits

This table includes HIPPA Audit table for Queries:
AUDITID
Action
RequestID
RecordID
TimeStamp
ActorFacility
ActorID
ActorCERT

TBL_Locations

This table includes a data locator for the actual file, including, for example:
RecID
LocID
FileName
TapeName
FileMarks
RecordMarks
BlockSize

TBL_Log

This table is the general table for log entries:
TimeStamp
DebugLevel
MachineName
Process
SubProcess
Action
Actionlong
ItemDescription
Result
ResultLong

TBL_Dicom_Small

This table stores the most frequently searched items:
RecID
H8H5, H8H8, H8H18, H8H20, H8H50, H8H60, H8H64, H8H80, H8H90, H8H100, H8H102, H8H104, H8H1010, H8H1030, H8H103E, H8H1050
H10H10, H10H20, H10H30, H10H40, H10H1010
H18H15, H18H5101
H20HD, H20HE, H20H10, H20H11, H20H13
H28H301
PatientAge

TBL_Main
This table includes the following: Recid
Format
FileLength
DateArrived

TBL_DICOM_ALL_A thru G

This table includes RecID followed by columns of the HjjHkkk form.

TBL_DICOM_Rest

This table includes all DICOM items not found in small, or ALL_A thru ALL_G.

TBL_Unique_ID

This table includes a lock mechanism for the database

### TBL XML

This table includes the contents of the original XML Header:
RecID
OriginalIP
OriginalTimeStamp
OriginalMessageNumber

### REQID

SenderFacility
SenderID
SenderCert

As explained in related application entitled, “NDMA SOCKET TRANSPORT PROTOCOL”, Attorney Docket UPN-4381/P3180, the NDMA protocol headers contain XML headers that form a virtual “envelope” for the DICOM transmission of a record. The database stores information from this header. The storage processor strips the envelope from the record, but preserves it in the file system.

### XML to SQL Query Translation

To enable queries of the medical records database 26 and/or the audits database 30, the ability to automatically translate an incoming XML expressed query into an SQL query appropriate for the internal database representation is implemented in accordance with the invention. This translation step provides security and efficiency benefits. First, the incoming XML is verified for correct formatting. Second, the translation blocks any attempt to execute arbitrary queries on the database. Third, it verified appropriate authorization and release criteria is verified for cross-enterprise requests, and fourth, it provides a mechanism to optimize query SQL. An example of the XML query syntax is shown in Table 1, below. Items in XML tags are translated to internal database names and tables (e.g., H10H10 in tbl_dicom_small). The query requirements can then be constructed including any required table joins. One purpose of the resulting internal SQL query is to identify record IDs that are then used in the locations tables to extract content. Content is automatically wrapped in the NDMA transport protocol and returned to locations specified in the original query. The process of query construction is table driven so the relationship between external XML tag names and internal database column names can be flexible.

The query translator 21 (FIG. 1) currently recognizes two different types of queries: research and clinical. Clinical queries are searches for patient records based on patient identifying information such as name, birthdate, internal hospital ID or others. Research queries can search for groups of patients whose records satisfy some criteria. Research requests are assumed to span across patients, and results are returned grouped into visits where a visit is specified as a name-date-facility combination, e.g., a patient seen on a particular date at a particular facility. Research request records are anonymized when returned by replacing patient names with an identifier constructed from the request number, the sequential patient number within the research records, and a trailing “NDMA”. Additionally, all identifiers are removed as specified for de-identified records according to HIPAA regulation.

The query translator in the case of research requests also searches the database for any additional reports or visits by the same patient at either the same facility or any other facility. Patients are linked between facilities by name, birthdate, and in some cases medical record number.

Special cross-reference records can be entered into the database to facilitate name and/or medical record number changes.

### Special Columns

The database storage routines provide for special values that can be stored in the index 28 as calculated values. This is done to facilitate rapid searches on quantities derived from the primary data but not directly contained in the records. One such example is patient age at time of exam. This is calculated when the data is received from the study date and the patient birthdate, both of which are contained in the DICOM record. The result is stored in a PatientAge column in the database. One reason for this is that this is a value that is expected to be frequently requested in research queries, and it would be inefficient to recalculate it or attempt to store it in a database view.

An example XML store request is presented below, followed by Table 1—An Example XML Query. The XML store request illustrates a message type, i.e., Storeimage, message identifier including the originating address, time stamp and originating message number. This is followed by the requested action for the message including identifier and priority description of authorization of sender including senders certificate and senders requesting facility identifier. This is followed by a description of the intended receiver, receiver certificate, and IP address, followed by a description of the payload including payload type and items of interest extracted from payload including patient identifiers and other items.

Example XML Store Request

```
    <?xml version=“1.0” encoding=“UTF-8” ?>
<Message type=“StoreImage”>
    <MessageID>
        <OriginalIP>130.91.51.20</OriginalIP>
        <Timestamp>5/12/2003 9:00:01 AM</Timestamp>
        <MessageNum>−13432</MessageNum>
        </MessageID>
    <Request action=“Store” type=“Image”>
        <ID>−13432</ID>
        <Priority>Routine</Priority>
        </Request>
    <Sender>
        <Certificate>xxxxxxxxx</Ceftificate>
        <Requestor>
              <Facility>NSCP</Facility>
              <ID>NSCP-6007</ID>
          </Requestor>
        </Sender>
    <Receiver>
        <Certificate> xxxxxxxxx </Certificate>
        <IP>130.91.51.20</IP>
        </Receiver>
    <Payload>
        <Record type=“Image” format=“DICOM”>
              <Item>
                    <Name>PatientID</Name>
                    <Value>pid_745566</Value>
              </Item>
                <Item>
                <Name>NamePatientFull</Name>
                <Value>dummy_745566</Value>
                </Item>
          </Record>
        </Payload>
    </Message>
```

The table below shows an example of NDMA protocol headers together with an XML query. Following the NDMA header, the XML specifies a Message type (in this case “QueryClinical”). That is followed by characteristics of the message including originator IP address, timestamp and message reference number. Next comes identifier information about the sender and the individual making the request, and the intended receiver. The next XML item specifies the action requested which in this case is a query including the query priority. Finally in the payload section is an XML specification of the query to be performed including values and items requested and operators that specify the logic of the query. This payload is translated by 42 for execution against the database.

TABLE 1
Example XML Query

NDMA/VERSION: 1.0
CONTENT-TYPE: XML
CONTENT-LENGTH: 877
<?xml version=“1.0” encoding=“UTF-8”?>
<Message type=“QueryClinical”>
<MessageID>
<OriginalIP>192.168.5.1</OriginalIP>
<Timestamp>1049898878</Timestamp>
<MessageNum>20806</MessageNum>
</MessageID>
<Sender>
<Certificate> XXXXXXXXX </Certificate>
<Requestor>
<Facility>SWCHSC</Facility>
<ID>Bob Hollebeek</ID>
<Certificate> XXXXXXXXX </Certificate>
</Requestor>
</Sender>
<Receiver>
<Certificate> XXXXXXXXX </Certificate>
<Ip>192.168.0.1</Ip>
</Receiver>
<Request action=“Query” type=“Clinical”>
<ID>20806</ID>
<Priority>LOW</Priority>
</Request>
<Payload>
<CriteriaGroup operator=“AND”>
<CriteriaItem operator=“EQUAL”>
<Name>NamePatientLast</Name>
<Value>XXXXXXXX\hat{ }</Value>
</CriteriaItem>
<CriteriaItem operator=“EQUAL”>
<Name>Facility</Name>
<Value>SWCHSC</Value>
</CriteriaItem>
</CriteriaGroup>
</Payload>
</Message>

As illustrated in FIG. 3, A translation scheme for translating DICOM content to a format compatible with an NDMA compatible relational database in accordance with embodiments of the present invention transforms the DICOM compatible data into an intermediate format and then transforms the intermediate formatted data into data compatible with the NDMA compatible relational database. The translation scheme in an exemplary embodiment translates DICOM compatible data into a tab delimited flat representation of the DICOM content. The flat representation of the DICOM content is translated into a relational database format, such as SQL. The database compatible representation is then formatted into database insert commands. The scheme enables capture of the DICOM information into relational tables. The DICOM content items are copied from but not removed from input records. Thus hospital records are preserved exactly as sent to the NDMA and as produced by the DICOM devices.

Arriving records are stored and indexed in the archive database in accordance with the index structured database schema. The DICOM content and private NDMA items are represented in XML. The XML is translated into database internal table and column representations. Arriving records, whether transported via NDMA or GRID compliant mechanisms, are automatically converted. The record contents comprising XML and DICOM components in an NDMA protocol or GRID wrapped NDMA protocols in a GRID protocol are automatically converted into database commands for storage in the archive medical records database 26. Arriving requests for content, whether transported via NDMA or GRID compliant mechanisms, are automatically converted. The requests for content comprising XML components in an NDMA protocol or GRID wrapped NDMA protocols in a GRID protocol are converted into database commands for query and retrieval in the archive database. The NDMA saves the XML transmission “envelopes” for future use in rebuilding, replicating, or moving archives.

Two types of queries are supported and distinguished by XML content in the request. The XML is easily extended to define additional types. The first type is a request for Clinical records. The second type is a request for research records. Queries are processed as described in accordance with FIG. 3 and requested records are passed to a “Reply Manager” 76 (FIG. 2). This process groups records into visits and identifies them as such in the returned XML headers along with the attached binary DICOM content wrapped in the NDMA protocol. Each record is individually returned with its own wrapper. The visit identifiers can be used to group records which share characteristics such as patient name, birthdate, patient ID and study date. Records returned from a query are of two types, differentiated by identifiers in the XML portions of the NDMA protocol. Clinical records are not de-identified, but research records are. All records are returned through the “ReplyPusher” process 78 (FIG. 2). The Reply Manager 76 for research requests returns records as part of a two step process. In the first step, only de-identified visit and report information is returned, but binary DICOM image content is not. The reply manager 76 encrypts locator information for the partially returned information in case the requestor wishes later to retrieve a de-identified copy of the image. The encrypted locator provides a stateless mechanism for retrieving this additional content and does not require re-execution of any database commands to locate the records. In a subsequent request, the requester can reference the encrypted locator, which will instruct the Reply Manager 76 to pull the requested records and send them through the ReplyPusher 78.

Many features are provided by the translation scheme described herein. The DICOM binary records are automatically translated into an intermediate format which is used as an interface between the binary formats and database processes. The DICOM (group, element) tags are automatically translated into database column and table names in an extensible manner. The DICOM (group, element) items are automatically categorized into levels of interest that control how they populate database tables. This enables more rapid index searching. The NDMA can calculate certain quantities during index creation and add them to the index to enable future searches based on these quantities. The list of such items is extensible. The NDMA database provides location information concerning the record provider which forms a virtual file room for an enterprise's data. The NDMA database supports isolation or sharing of data from one enterprise to another. A mechanism is provided for verifying authorization of the movement of records across enterprise boundaries. The NDMA provides an XML syntax for record queries and automatically verifies the syntax. The verified and authorized XML specified queries are automatically translated into optimized SQL. The NDMA also provides a method whereby infrequently used DICOM (group, element) tags can nevertheless be stored in the database for future queries. The NDMA provides a mechanism for storing BiRADs content in the relational database. The NDMA also provides a mechanism for querying BiRADS information to form de-identified collections of research visits whose summary information can be displayed at the hospital. The NDMA provides a state-less method for allowing hospitals to select a subsample from de-identified summaries and to acquire de-identified records for such cases from the medical records archive 26.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed:

1. A method for transforming digital imaging and communications in medicine (DICOM) compatible data into national digital mammography archive (NDMA) relational database compatible data, said method comprising the steps of:
transforming said DICOM compatible data into data formatted in accordance with an intermediate format; and
transforming said intermediate formatted data into data compatible with said NDMA compatible relational database.

2. A method in accordance with claim 1, further comprising the steps of:
parsing searchable and indexable elements of a DICOM header of said DICOM compatible data; and
transforming said parsed elements into components of said intermediate format.

3. A method in accordance with claim 2, further comprising the step of:
transforming each of said components of said intermediate format into one of a table indicator, a column indicator and a command compatible with said relational database.

4. A method in accordance with claim 3, further comprising the steps of:
associating each column of said relational database with a database table in accordance with a level of interest of DICOM compatible data in said column.

5. A method in accordance with claim 4, wherein said level of interest includes at least one of:
a first level of interest indicative of DICOM compatible data most likely to be queried;
a second level of interest indicative of DICOM compatible data less likely to be queried than said first level of interest; and
a third level of interest indicative of DICOM compatible data that is not included in said first and second levels of interest.

6. A method in accordance with claim 5, wherein:
DICOM compatible data belonging to said third level is indexable in said database.

7. A method in accordance with claim 1, wherein said DICOM compatible data comprises extensible markup language (XML) formatted text, said method further comprising the step of transforming said XML formatted text into data compatible with said NDMA compatible relational database.

8. A method in accordance with claim 7, wherein said XML text comprises XML requests and said relational database supports structured query language (SQL) queries contained in said XML requests.

9. A method in accordance with claim 1, wherein:
said DICOM compatible data comprises at least one of NDMA protocol wrapped DICOM data, DICOM structured reports, selected DICOM compatible data, and an Open Grid Standard compatible request.

10. A method in accordance with claim 9, wherein:
said Open Grid Standard compatible request comprises at least one of a service request, a storage request, and a retrieval request.

11. A method in accordance with claim 1, wherein said intermediate format comprises a tab delimited flat representation of said DICOM compatible data.

12. A method in accordance with claim 11, further comprising the step of serializing, wherein said intermediate format is serializable.

13. A method in accordance with claim 11, wherein said intermediate format comprises:
a group and element indicator indicative of a group and element, respectively, to which said DICOM compatible data belongs;
a length indicator indicative of a length of said DICOM compatible data;
a value representation of said DICOM data; and
a description of said DICOM compatible data.

14. A method in accordance with claim 13, wherein said DICOM compatible data comprises at least one group/element pair, said method further comprising for each pair:
translating DICOM items into table column names;
appending an identifier “H” to a beginning of each group;
appending an identifier “H” to a beginning of each element;
concatenating said appended group and said appended element; and
associating each concatenated group/concatenated element with a column of a relational database.

15. A method in accordance with claim 1, wherein:
only authorized DICOM compatible data is transformed; and
authorized DICOM compatible data is transformed into selected relational database indicators to ensure efficient querying of said relational database.

16. A method in accordance with claim 1, wherein DICOM compatible data is transformed for only authorized enterprises.

17. A method in accordance with claim 1, wherein:
responsive to a clinical query for transformed DICOM compatible data, DICOM compatible data having patient identification information is provided; and
responsive to a research query for transformed DICOM compatible data, de-identified DICOM compatible data is provided.
